(19) United States
(12) Patent Application Publication
(10) Pub. No.: US 2009/0130015 A1
(43) Pub. Date: May 21, 2009

(54) Method for producing high purity silicon

(75) Inventors: Kunio Saegusa, Ibaraki (JP); Toshiharu Yamabayashi, Ibaraki (JP)

Correspondence Address: BIRCH STEWART KOLASCH & BIRCH, PO BOX 747, FALLS CHURCH, VA, 22040-0747, US

(73) Assignee: Sumitomo Chemical Company, Limited, Tokyo (JP)

(21) Appl. No.: 11/921,940

(22) PCT Filed: Jun. 28, 2006
(86) PCT No.: PCT/JP2006/313363

§ 371 Date: Jul. 31, 2008

(30) Foreign Application Priority Data
Jun. 29, 2005 (JP) 2005-189454

(51) Int. Cl. C01B 33/023

(52) U.S. Cl. 423/350

(57) ABSTRACT

The present invention provides a method for producing high purity silicon. The method for producing high purity silicon comprises a step of reducing halogenated silicon represented by the following formula (1) with aluminum, wherein the aluminum used as a reductant has a purity of not less than 99.9% by weight,

SiHₙX₄₋ₙ (1)

wherein n is an integer of 0 to 3, X is at least one halogen selected from the group consisting of F, Cl, Br and I; and the purity of the aluminum is the balance obtained by deducting the total % by weight of iron, copper, gallium, titanium, nickel, sodium, magnesium and zinc contained in the aluminum from 100% by weight.

### TECHNICAL FIELD

The present invention relates to a method for producing high purity silicon.

### BACKGROUND ART

As a silicon material used for solar cells, an off-grade product of a semiconductor grade silicon is used as a main material. The semiconductor grade silicon is produced by purifying a metallurgical grade silicon. The metallurgical grade silicon is produced by mixing carbon and silica and reducing the mixture in an arc furnace. The metallurgical grade silicon is reacted with HCl to obtain trichlorosilane, and trichlorosilane is purified by distillation, then, reduced at high temperature using hydrogen, thereby producing the semiconductor grade silicon. This method is capable of producing ultra high purity silicon, however, shows high cost because of facts that the conversion to silicon is low, and a large amount of hydrogen is necessary for rendering this equilibrium advantageous for silicon; that its conversion rate is low even after the above-described procedure, and a large amount of unreacted gas should be recycled and used again; that various halogenated silanes are generated after the reaction, and these should be separated by distillation again; that a large amount of silicon tetrachloride which cannot be reduced with hydrogen finally is generated, and the like.

On the other hand, solar cells are paid attention as an effective solution against recent environmental problems due to a carbon dioxide gas and the like, and demand for the solar cells is increasing remarkably.

However, conventional solar cells are sill expensive, and the price of electric power generated by the solar cells is higher by several times as compared with the electricity expense of commercial electricity. Demand for solar cells is increasing in response to environmental problems and increasing energy demand, as a result, a lack of the material cannot be compensated only by conventional semiconductor off-grade silicon, causing a demand for supply of a large amount of low cost solar cells.

Conventionally, there are various suggestions such as a method of reducing silicon tetrachloride with aluminum (Shiro Yoshizawa, Asao Mizuno, Arata Sakaguchi, Reduction of Silicon Tetrachloride with Aluminum, Industrial Chemistry Journal vol. 64(8), pp. 1347-50 (1961), JP-A Nos. 2-64006 and 59-18221); a method of reducing silicon tetrachloride with zinc (Evaluation of selected chemical processes for production of low-cost silicon, J. M. Blocher, et. al. Jet propulsion laboratory final report (1981)); fluidized bed reduction of trichlorosilane (1980-1987 New Energy Comprehensive Development Organization Commissioned Business Achievement Report 1980-1987 “Solar Light Electric Generation System Practical Realization Technology Development, Low Cost Silicon Experiment Purification Verification” Summary, 1988, Shin-Etsu Chemical Co., Ltd.); and the like, however, none of them have been put into practical use yet.

### DISCLOSURE OF THE INVENTION

The present invention has an object of providing a novel and inexpensive method for producing high purity silicon which is suitably used as a material for solar cells, and high purity silicon obtained by the method.

The present inventors have intensively studied a method for producing high purity silicon, resultantly leading to completion of the present invention.

That is, the present invention provides

[1] a method for producing high purity silicon by reducing halogenated silicon represented by the following formula (1) with an aluminum wherein the aluminum used as a reductant has a purity of not less than 99.9% by weight:

SiHₙX₄₋ₙ (1)

wherein n is an integer of 0 to 3, and X is at least one halogen selected from the group consisting of F, Cl, Br and I; and the purity of the aluminum is the balance obtained by deducting the total % by weight of iron, copper, gallium, titanium, nickel, sodium, magnesium and zinc contained in the aluminum from 100% by weight.

Further, the present invention provides

[2] the method according to [1], wherein the aluminum has a boron content of not more than 5 ppm, and a phosphorus content of not more than 0.5 ppm,

[3] the method according to [1] or [2], wherein the aluminum has a boron content of not more than 0.5 ppm, a phosphorus content of not more than 0.3 ppm,

[4] the method according to any one of [1] to [3], wherein the aluminum has an iron content of not more than 150 ppm, a copper content of not more than 290 ppm, a titanium content of not more than 7 ppm, and a vanadium content of not more than 20 ppm,

[5] the method according to any one of [1] to [4], wherein the aluminum has an iron content X_{Fe} ppm, a copper content X_{Cu} ppm, and a titanium content X_{Ti} ppm, which satisfy the condition of X_{Fe}/150+X_{cu}/290+X_{Ti}/7+X_{V}/20≦1,

[6] the method according to any one of [1] to [5], wherein the aluminum has an iron content of not more than 10 ppm,

[7] the method according to any one of [1] to [6], wherein the aluminum has an iron content of not more than 10 ppm, a copper content of not more than 10 ppm, a titanium content of not more than 1 ppm, and a vanadium content of not more than 5 ppm,

[8] the method according to any one of [1] to [7], wherein the aluminum has an iron content of not more than 3 ppm, a copper content of not more than 3 ppm, a titanium content of not more than 0.3 ppm, and a vanadium content of not more than 1 ppm,

[9] the method according to [1], wherein the aluminum has a purity of not less than 99.99%,

[10] the method according to [9], wherein the aluminum has an iron content of not more than 10 ppm, a copper content of not more than 10 ppm, a titanium content of not more than 1 ppm, and a vanadium content of not more than 5 ppm,

[11] the method according to[9] or [10], wherein the aluminum has an iron content of not more than 3 ppm, a copper content of not more than 3 ppm, a titanium content of not more than 0.3 ppm, and a vanadium content of not more than 1 ppm,

[12] the method according to any one of [9] to [11], wherein the aluminum has a boron content of not more than 0.5 ppm, and a phosphorus content of not more than 0.3 ppm,

[13] the method according to any one of [1] to [12], wherein the halogenated silicon has a purity of not less than 4 N, and

[14] the method for producing high purity silicon comprising purifying silicon obtained by the method according to any one of [1] to [13] by directional solidification

### MODES FOR CARRYING OUT THE INVENTION

The method for producing high purity silicon of the present invention is a method for producing silicon by reducing halogenated silicon represented by the above-described formula (1) with an aluminum, wherein the aluminum used as a reductant has a purity of not less than 99.9% by weight. In the invention, the purity of the aluminum is the balance obtained by deducting the total % by weight of iron, copper, gallium, titanium, nickel, sodium, magnesium and zinc contained in the aluminum from 100% by weight. The purity of silicon is the balance obtained by deducting the total % by weight of iron, copper, gallium, titanium, nickel, sodium, magnesium and zinc contained in the silicon from 100% by weight. In the invention, purity analysis may be carried out by a glow discharge mass spectrometry.

Examples of the halogenated silicon include silicon tetrachloride, trichlorosilane, dichlorosilane and monochlorosilane, preferably silicon tetrachloride from the standpoint of cost. The high purity halogenated silicon produced by a well-known method may be used. Examples of the method include a method including a step of chlorinating silica in the presence of carbon at a temperature of 1000 to 1400° C.; a method including a step of reacting a metallurgical grade silicon with chlorine or hydrogen chloride. The resultant halogenated silicon is distilled to obtain high purity halogenated silicon having a purity of not less than 6 N (99.9999%).

The halogenated silicon used in the present invention has a purity of preferably not less than 4 N (99.99%), more preferably not less than 6 N and further preferably not less than 7 N (99.99999%). In particular, the halogenated silicon has a phosphorus (P) content or boron (B) content of preferably not more than 0.5 ppm, more preferably not more than 0.3 ppm and further preferably not more than 0.1 ppm.

In the present invention, the aluminum used as a reductant has a purity of not less than 99.9% by weight, more preferably not less than 99.99% by weight and further preferably not less than 99.995% by weight.

Each element of iron, copper, gallium, titanium, nickel, sodium, magnesium and zinc may be purified by directional solidification. From the standpoint of improving a yield in a step of directional solidification, the aluminum has

an iron content of preferably not more than 150 ppm, more preferably not more than 30 ppm, further preferably not more than 10 ppm and particularly preferably not more than 3 ppm;

a copper content of preferably not more than 290 ppm, more preferably not more than 30 ppm, further preferably not more than 10 ppm and particularly preferably not more than 3 ppm;

a titanium content of preferably not more than 30 ppm, more preferably not more than 10 ppm, further preferably not more than 7 ppm, particularly preferably not more than 3 ppm, more particularly preferably not more than 1 ppm and even more particularly preferably not more than 0.3 ppm;

a nickel content of preferably not more than 300 ppm, more preferably not more than 30 ppm, further preferably not more than 10 ppm, particularly preferably not more than 3 ppm and more particularly not more than 1 ppm;

a sodium content of preferably not more than 300 ppm, more preferably not more than 30 ppm, further preferably not more than 10 ppm and particularly preferably not more than 3 ppm;

a magnesium content of preferably not more than 300 ppm, more preferably not more than 30 ppm, further preferably not more than 10 ppm and particularly preferably not more than 3 ppm; and a zinc content of preferably not more than 300 ppm, more preferably not more than 30 ppm, further preferably not more than 10 ppm and particularly preferably not more than 3 ppm.

The aluminum has a phosphorus content of preferably not more than 0.5 ppm, more preferably not more than 0.3 ppm, further preferably not more than 0.1 ppm. Because phosphorus is one of other elements than these elements contained in aluminum, and is not removed from the aluminum by directional solidification which may be carried out as a step of silicon purification.

The aluminum has boron content of preferably not more than 5 ppm, more preferably not more than 1 ppm and further preferably not more than 0.3 ppm, since no boron is also removed by directional solidification.

Moreover, The aluminum has a vanadium content of preferably not more than 20 ppm, more preferably not more than 5 ppm, further preferably not more than 1 ppm and particularly preferably not more than 0.1 ppm.

The total value of these influential elements is not more than the preferable value, and additionally, it is preferable that the aluminum has an iron content X_{Fe} ppm, a copper content X_{Cu} ppm, and a titanium content X_{Ti} ppm, which satisfy the condition of X_{Fe}/150+X_{Cu}/290+X_{Ti}/7+X_{V}/20≦1,

The aluminum used in the invention may be prepared by purifying commercially available electrolytically reduced aluminum (primary aluminum) by segregation solidification, three layer electrolysis and the like.

The aluminum may have a form of foil, powder, molten solution or the like. From the standpoint of a reaction rate, the aluminum may preferably have a form having as large surface area as possible.

In the method, the reaction may be carried out by a method of charging the aluminum into a heat-resistant reactor and feeding halogenated silicon to the reactor at given temperature; a method of feeding the aluminum and halogenated silicon simultaneously into a reactor; and the like.

The reaction temperature is preferably 400° C. to 1200° C., more preferably 500° C. to 1200° C., further preferably 500° C. to 1000° C., more further preferably 660° C. to 1000° C. and particularly preferably 700° C. to 1000° C. The reaction temperature is preferably not lower than 400° C. from the standpoint of accelerating a reaction rate. The reaction temperature is preferably not higher than 1200° C. from the standpoint of preventing generation of a lower order halogenated silicon from a reaction between halogenated silicon and a reaction product, and decrease of a silicon yield.

The reactor is preferably made of material which is heat-resistant at the reaction temperature and does not contaminate silicon. Examples of the material include carbon, silicon carbide, silicon nitride, alumina, and quartz.

In the method, halogenated silicon may be diluted with an inert gas before feeding, to control a reaction rate. Examples of the inert gas include argon, and nitrogen.

In the reaction, purified silicon and by-product are produced. Examples of the by-product include aluminum chloride. Since aluminum chloride is in the form of gas above 200° C., silicon is preferably separated from a mixture containing unreacted halogenated silicon gas, dilution gas and aluminum chloride gas by solid-gas separation at a temperature above 200° C.

It is preferable that the mixture containing the unreacted halogenated silicon gas, dilution gas and aluminum chloride gas is preferably cooled to a temperature below 200° C., and that aluminum chloride solid is separated from a mixture containing the unreacted halogenated silicon gas and dilution gas.

The unreacted halogenated silicon is, if necessary, separated from the dilution gas, and may be used in the reaction with aluminum. Separation from the dilution gas may be carried out by gas-liquid separation after condensing the halogenated silicon gas into liquid

In the method, the resultant aluminum chloride has ultra high purity. Therefore, the aluminum chloride may be used without modification in the form of anhydrous aluminum chloride as a catalyst. The aluminum chloride may be reacted with water to obtain polyaluminum chloride, and the polyaluminum chloride may be neutralized to obtain aluminum hydroxide. The aluminum chloride may be reacted with water vapor or oxygen at high temperature to obtain alumina.

In the method, a reaction between a halogenated silicon and aluminum has large negative free energy of reaction, and the reaction proceeds at the stoichiometric ratio in equilibrium theory. From the standpoint of kinetics and separation step, it is preferable excess amount of the halogenated silicon over aluminum is used in the reaction.

In the method, the reaction atmosphere is preferably halogenated silicon gas, or a mixture containing halogenated silicon gas and inert gas. From the standpoint of improving a reaction rate, it is preferable the reaction atmosphere is free from water and oxygen.

When the reaction atmosphere contains hydrogen chloride, a consumption rate of aluminum may be lower according to the amount of the hydrogen chloride. On the other hand, silicon is expected to be highly purified. If highly purification is needed, the necessary minimum amount of hydrogen chloride may be used.

In the method, the reaction time is preferably not shorter than 1 second and not longer than 48 hours, more preferably not shorter than 5 seconds and not longer than 48 hours, further preferably not shorter than 10 seconds and not longer than 48 hours, more further preferably not shorter than 10 seconds and not longer than 60 minutes and particularly preferably not shorter than 10 seconds and not longer than 10 minutes, depending on reaction mode. The reaction proceeds faster when the aluminum is finer. The preferable reaction time depends on the form of the aluminum. When the reaction time is too short, unreacted aluminum remains to constitute an impurity in silicon undesirably. When it is too long, it results in high manufacturing cost though there is no disadvantage in yield.

The silicon obtained by the method may have a small amount of aluminum according to the reaction conditions. If necessary, it is preferable that the silicon is ground, and washed with an acid to remove aluminum. The acid has preferably a small amount of metal impurities. Examples of the acid include hydrochloric acid, nitric acid, sulfuric acid.

Embodiments of the present invention are illustrated in the above description. The embodiments are only exemplary, and the scope of the invention is not limited to these embodiments. The scope of the present invention is recited in Claims, and includes all variations within meanings and ranges equivalent to the descriptions of Claims.

### EXAMPLES

The present invention will be illustrated by examples below, but the present invention is not limited to them.

In purity analysis in measurement described below, a glow discharge mass spectrometry (manufactured by VG Corp., VG-9000) was used. Diffusion length was measured by Surface PhotoVoltge (SPV) (manufactured by SDI Corp., CMS4010). Silicon with a diffusion length of not shorter than 50μ is available for a solar cell.

### Example 1

5 g of high purity aluminum (manufactured by Sumitomo Chemical Co., Ltd., form: plate, thickness: 1 mm, composition: see Table 1) was charged in an alumina crucible. The crucible was placed in a quartz tube of an electric furnace.

Ar gas was passed through a cylinder filled with silicon tetrachloride (manufactured by Tri Chemical K.K., purity: 6 N) at a rate of 400 cc/min to obtain a mixture containing silicon tetrachloride gas and Ar gas. The mixture was fed into the quartz tube kept at 900° C. The aluminum was reacted with silicon tetrachloride for about 1 hour. Then, Ar gas was fed thereto instead of the mixture. The quartz tube was cooled.

After completion of the reaction, the resultant silicon was taken out, ground, washed with dilute hydrochloric acid, then with pure water, then, dried, and its purity was analyzed.

Impurities (unit: ppm) in high purity aluminum and the silicon were shown in Table 1. Ultra high purity silicon was obtained. The high purity aluminum had a purity of 99.9996% (impurity total: 3.72 ppm). The silicon had a purity of 99.9999% (impurity total: 0.95 ppm).

### Comparative Example 1

5 g of primary aluminum (manufactured by Sumitomo Chemical Co., Ltd., thickness: 1 mm, composition: see Table 2) was charged in an alumina crucible. The crucible was placed in a quartz tube of an electric furnace. Ar gas was passed through a cylinder filled with silicon tetrachloride (manufactured by Tri Chemical K.K., purity: 6 N) at a rate of 400 cc/min. The mixture containing silicon tetrachloride gas and Ar gas was fed into the quartz tube kept at 900° C., and aluminum was reacted with silicon tetrachloride for about 1 hour. Ar was fed thereto instead of the mixture. The quartz tube was cooled.

After completion of the reaction, the resultant silicon was taken out, ground, washed with dilute hydrochloric acid, then with pure water, then, dried, and its purity was analyzed.

Impurities (unit: ppm) of primary aluminum and that of the resultant silicon were shown in Table 2. The primary aluminum had a purity of 99.28% (impurity total: 72×10² ppm). The silicon had a purity of 99.21% (impurity total: 79×10² ppm).

It is understood that impurities in aluminum were transferred into silicon. The silicon had a purity of about 99% by weight. The purity of silicon is insufficient for solar cells even if purified later.

### Example 2

SiCl₄ was reduced using aluminum having an impurity composition shown in Table 3 to obtain silicon. The impurities of the silicon were determined to obtain results as shown in Table 3. As a result, regarding the behavior of impurities, it was found that impurities such as Fe, Cu, Ti, Ni, B and P in Al were transferred almost as there were into silicon, and that Cr, V, Zr, Mo, Zn and the like decreased to 1/10 in from Al into Si. Therefore, it is understood that aluminum containing Cr, V, Zr, Mo and Zn in concentration higher by about 10-fold than the permissible concentration in silicon may be used as a raw material.

### Example 3

SiCl₄ was reduced using a reductant prepared by adding 150 ppm of Fe to the aluminum used in Example 1 to obtain silicon. The silicon had a Fe content of 140 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 70%.

### Example 4

SiCl₄ was reduced using a reductant prepared by adding 300 ppm of Cu to the aluminum used in Example 1 to obtain silicon. The silicon had a Cu content of 280 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 75%.

### Example 5

SiCl₄ was reduced using a reductant prepared by adding 7 ppm of Ti to the aluminum used in Example 1 to obtain silicon. The silicon had a Ti content of 7 ppm and a Fe content of 0.5 ppm. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 65%.

### Example 6

SiCl₄ was reduced using a reductant prepared by adding 20 ppm of V to the aluminum used in Example 1 to obtain silicon. The silicon had a V content of 1.1 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 70%.

### Example 7

SiCl₄ was reduced using a reductant prepared by adding 10 ppm of Fe to the aluminum used in Example 1 to obtain silicon. The silicon had a Fe content as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 85%.

### Example 8

SiCl₄ was reduced using a reductant prepared by adding 3 ppm of Fe to the aluminum used in Example 1 to obtain silicon. The silicon had a Fe content of 3 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 90%.

### Example 9

SiCl₄ was reduced using a reductant prepared by adding 0.3 ppm of Ti to the aluminum used in Example 1 to obtain silicon. The silicon had a Ti content of 0.3 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 85%.

### Example 10

SiCl₄ was reduced using a reductant prepared by adding 1 ppm of V to the aluminum used in Example 1 to obtain silicon. The silicon had a V content of 0.1 ppm as a main impurity. The silicon was directionally solidified at a rate of 0.4 mm/min to obtain an ingot having 180 mm square and a height of 120 mm. The diffusion length of the ingot was measured. In the ingot, the area with a diffusion length of not shorter than 50 μm was 80%.

TABLE 1

| | | Resultant |
|---|---|---|
| Impurity | Aluminum | silicon |
| element | (unit: ppm) | (unit: ppm) |
| B | 0.05 | 0.03 |
| Na | 0.02 | 0.1 |
| Mg | 0.45 | <0.05 |
| P | 0.27 | 0.25 |
| S | 0.13 | 0.27 |
| Fe | 0.73 | 0.52 |
| Co | <0.005 | <0.01 |
| Ni | 0.02 | 0.02 |
| Ti | 0.03 | 0.11 |
| Cu | 1.9 | <0.05 |
| Zn | <0.05 | <0.05 |
| Ga | 0.57 | <0.05 |
| V | 0.01 | <0.01 |

TABLE 2

| | | Resultant |
|---|---|---|
| Impurity | Aluminum | silicon |
| element | (unit: ppm) | (unit: ppm) |
| B | 15 | 1.6 |
| Na | 0.29 | 0.03 |
| Mg | 35 | 0.1 |
| P | 2.2 | 6.1 |
| S | 0.35 | 0.39 |
| Fe | 5500 | 6500 |
| Co | 0.95 | 1.3 |
| Ni | 60 | 63 |
| Ti | 45 | 20 |
| Cu | 1500 | 1200 |
| Zn | 35 | <0.5 |
| Ga | 100 | 69 |

TABLE 3

| | | Resultant |
|---|---|---|
| Impurity | Aluminum | silicon |
| element | (unit: ppm) | (unit: ppm) |
| B | 2.1 | 8 |
| Na | 0.15 | 3.1 |
| Mg | <0.05 | 0.4 |
| P | 0.08 | 3.3 |
| S | 0.07 | 3 |
| Fe | 22 | 5.7 |
| Co | 0.04 | 0.05 |
| Ni | 1.5 | 5.5 |
| Ti | 2.5 | 1.6 |
| Cu | 0.52 | 0.47 |
| Zn | 0.89 | <0.05 |
| Ga | 10 | <0.05 |
| V | 2.2 | 0.13 |

### INDUSTRIAL APPLICABILITY

According to the method of the present invention, high purity silicon (for example, purity: not less than 5 N, preferably not less than 6 N, boron content: not more than 1 ppm, phosphorus content: not more than 0.3 ppm) is obtained. The high purity silicon is suitably used as a material for solar cells.

1. A method for producing high purity silicon comprising a step of reducing halogenated silicon represented by the following formula (I) with aluminum, wherein the aluminum used as a reductant has a purity of not less than 99.9% by weight,
SiHₙX₄₋ₙ (1)
wherein n is an integer of 0 to 3, X is at least one halogen selected from the group consisting of F, Cl, Br and I; and the purity of the aluminum is the balance obtained by deducting the total % by weight of iron, copper, gallium, titanium, nickel, sodium, magnesium and zinc contained in the aluminum from 100% by weight.

2. The method according to claim 1, wherein the aluminum has a boron content of not more than 5 ppm, and a phosphorus content of not more than 0.5 ppm.

3. The method according to claim 1 or 2, wherein the aluminum has a boron content of not more than 0.5 ppm, a phosphorus content of not more than 0.3 ppm.

4. The method according to claim 1, wherein the aluminum has an iron content of not more than 150 ppm, a copper content of not more than 290 ppm, a titanium content of not more than 7 ppm, and a vanadium content of not more than 20 ppm.

5. The method according to claim 1, wherein the aluminum has an iron content X_{Fe} ppm, a copper content X_{Cu} ppm, and a titanium content X_{Ti} ppm, which satisfy the condition of X_{Fe}/150+X_{Cu}/290+X_{Ti}/7+X_{V}/20≦1,

6. The method according to claim 1, wherein the aluminum has an iron content of not more than 10 ppm.

7. The method according to claim 1, wherein the aluminum has an iron content of not more than 10 ppm, a copper content of not more than 10 ppm, a titanium content of not more than 1 ppm, and a vanadium content of not more than 5 ppm.

8. The method according to claim 1, wherein the aluminum has an iron content of not more than 3 ppm, a copper content of not more than 3 ppm, a titanium content of not more than 0.3 ppm, and a vanadium content of not more than 1 ppm.

9. The method according to claim 1, wherein the aluminum has a purity of not less than 99.99%.

10. The method according to claim 9, wherein the aluminum has an iron content of not more than 10 ppm, a copper content of not more than 10 ppm, a titanium content of not more than 1 ppm, and a vanadium content of not more than 5 ppm.

11. The method according to claims 9 or 10, wherein the aluminum has an iron content of not more than 3 ppm, a copper content of not more than 3 ppm, a titanium content of not more than 0.3 ppm, and a vanadium content of not more than 1 ppm.

12. The method according to claim 9, wherein the aluminum has a boron content of not more than 0.5 ppm, and a phosphorus content of not more than 0.3 ppm.

13. The method according to claim 1, wherein the halogenated silicon has a purity of not less than 4 N.

14. The method for producing high purity silicon comprising purifying silicon obtained by the method according to claim 1 by directional solidification.
